(19) United States
(12) Patent Application Publication
(10) Pub. No.: US 2017/0331158 A1
(43) Pub. Date: Nov. 16, 2017

(54) NONAQUEOUS ELECTROLYTE SECONDARY BATTERY

(71) Applicant: SANYO Electric Co., Ltd., Daito-shi, Osaka (JP)

(72) Inventors: Daizo Jito, Osaka (JP); Akihiro Kawakita, Hyogo (JP); Takeshi Ogasawara, Hyogo (JP)

(73) Assignee: SANYO Electric Co., Ltd., Daito-shi, Osaka (JP)

(21) Appl. No.: 15/522,179

(22) PCT Filed: Feb. 15, 2016
(86) PCT No.: PCT/JP2016/000757

§ 371 Date: Apr. 26, 2017

(30) Foreign Application Priority Data
Feb. 26, 2015 (JP) 2015-036836

(51) Int. Cl. H01M 10/42; H01M 10/0568; H01M 4/525

(52) U.S. Cl. CPC H01M 10/4235; H01M 4/525; H01M 10/0568

(57) ABSTRACT

Provided is a nonaqueous electrolyte secondary battery capable of limiting an increase in DCR which occurs after the battery has been subjected to cycles of charging and discharging. A nonaqueous electrolyte secondary battery according to an exemplary embodiment includes a positive electrode including a positive electrode active material. The positive electrode active material includes a secondary particle of a lithium transition metal oxide which is formed by coagulation of primary particles of the lithium transition metal oxide and secondary particles of a rare earth compound which are each formed by coagulation of primary particles of the rare earth compound. The secondary particles of the rare earth compound are each deposited on a groove between a pair of adjacent primary particles of the lithium transition metal oxide, the groove being formed in a surface of the secondary particle of the lithium transition metal oxide, so as to come into contact with both of the pair of adjacent primary particles of the lithium transition metal oxide in the groove. The nonaqueous electrolyte includes lithium difluorophosphate.

### TECHNICAL FIELD

The present invention relates to a nonaqueous electrolyte secondary battery.

### BACKGROUND ART

There have been demands for nonaqueous electrolyte secondary batteries having high capacities with which the batteries can be used for a prolonged period of time and improved output characteristics with which the batteries are capable of being charged and discharged with a large current in a relatively short period of time.

For example, PTL 1 suggests that depositing an element belonging to Group 3 of the periodic table on the surfaces of base particles of a positive electrode active material may limit the reaction between the positive electrode active material and an electrolyte solution even when the charging voltage is high and this may limit the degradation of the charge-conservation characteristics.

PTL 2 suggests that adding lithium difluorophosphate (LiPO₂F₂) to an electrolyte may reduce the I-V resistance of a battery that has not been subjected to cycles of charging and discharging and the amount of gas generated when the battery is stored at high temperatures.

### CITATION LIST

### Patent Literature

PTL 1: International Publication No. 2005/008812

PTL 2: Japanese Published Unexamined Patent Application No. 2014-7132

### SUMMARY OF INVENTION

### Technical Problem

However, it was found that, even when the techniques disclosed in PTLs 1 and 2 are used, the direct current resistance (hereinafter, abbreviated as “DCR”) of a battery may be increased, that is, the output characteristic of the battery may be degraded, after the battery has been subjected to cycles of charging and discharging.

Accordingly, an object of the present invention is to provide a nonaqueous electrolyte secondary battery capable of limiting the increase in the DCR of the battery which occurs after the battery has been subjected to cycles of charging and discharging.

### Solution to Problem

A nonaqueous electrolyte secondary battery according to the present invention includes a positive electrode, a negative electrode, and a nonaqueous electrolyte. The positive electrode includes a positive electrode active material. The positive electrode active material includes a secondary particle of a lithium transition metal oxide which is formed by coagulation of primary particles of the lithium transition metal oxide, and secondary particles of a rare earth compound which are each formed by coagulation of primary particles of the rare earth compound. The secondary particles of the rare earth compound are each deposited on a groove between a pair of adjacent primary particles of the lithium transition metal oxide which is formed in a surface of the secondary particle of the lithium transition metal oxide so as to come into contact with both of the pair of adjacent primary particles of the lithium transition metal oxide in the groove. The nonaqueous electrolyte includes lithium difluorophosphate.

### Advantageous Effects of Invention

The nonaqueous electrolyte secondary battery according to the present invention may limit the increase in the DCR of the battery which occurs after the battery has been subjected to cycles of charging and discharging.

### BRIEF DESCRIPTION OF DRAWINGS

FIG. 1 is a schematic front view of a nonaqueous electrolyte secondary battery according to an exemplary embodiment.

FIG. 2 is a cross-sectional view of the battery illustrated in FIG. 1, taken along Line A-A of FIG. 1.

FIG. 3 includes a schematic cross-sectional view of a particle of a positive electrode active material according to an exemplary embodiment and magnified schematic cross-sectional views of a part of the particle of the positive electrode active material.

FIG. 4 is a magnified schematic cross-sectional view of a part of a particle of a positive electrode active material prepared in Test Example 3 or 4.

FIG. 5 is a magnified schematic cross-sectional view of a part of a particle of a positive electrode active material prepared in Test Example 5 or 6.

### DESCRIPTION OF EMBODIMENTS

Embodiments of the present invention are described below. The embodiments below are merely exemplary embodiments of the present invention and do not limit the present invention. Various modifications may be made without changing the scope of the present invention. The drawings used as references in the embodiments and Test Examples below are schematics; the dimensions, quantities, and the like of the components illustrated in the drawings may be different from those of the actual components.

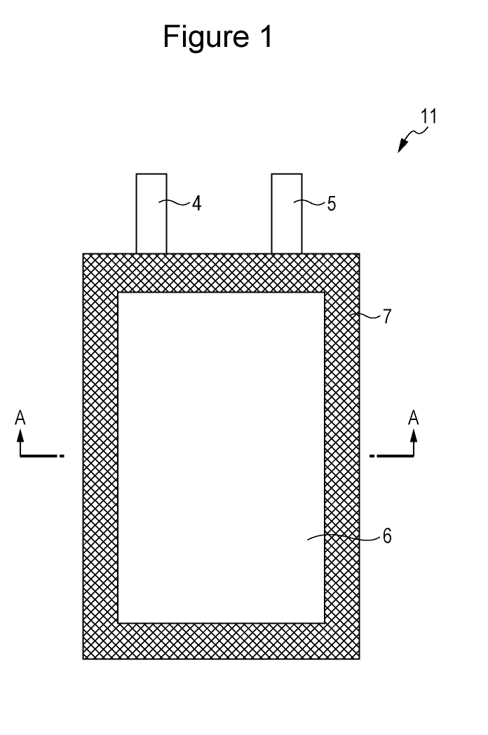

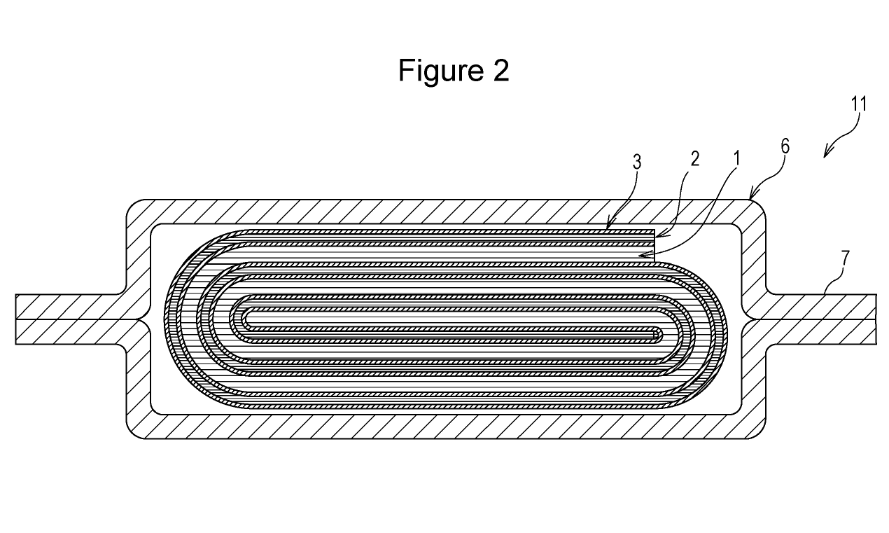

FIG. 1 is a schematic front view of a nonaqueous electrolyte secondary battery according to an exemplary embodiment. FIG. 2 is a cross-sectional view of the battery illustrated in FIG. 1, taken along Line A-A of FIG. 1. As illustrated in FIGS. 1 and 2, a nonaqueous electrolyte secondary battery 11 includes a positive electrode 1, a negative electrode 2, and a nonaqueous electrolyte (not shown). The positive electrode 1 and the negative electrode 2, with the separator 3 interposed therebetween, are wound into a spiral form to form a flat electrode group together with the separator 3. The nonaqueous electrolyte secondary battery 11 includes a positive electrode current collector tab 4, a negative electrode current collector tab 5, and an aluminum-laminated case 6 including a closure portion 7, which is formed by joining the peripheries of parts of the aluminum-laminated case to each other by heat sealing. The aluminum-laminated case 6 houses the flat electrode group and the nonaqueous electrolyte. The positive electrode 1 is connected to the positive electrode current collector tab 4. The negative electrode 2 is connected to the negative electrode current collector tab 5. Thus, the structure of a secondary battery that can be charged and discharged is formed. The nonaqueous electrolyte included in the nonaqueous electrolyte secondary battery 11 contains lithium difluorophosphate as described below in detail.

Although the example illustrated in FIGS. 1 and 2 is a lamination-film-packed battery including the flat electrode group, the type of battery to which the present disclosure can be applied is not limited to this. The shape of the battery may be, for example, cylindrical, rectangular, or coin-like.

The components of the nonaqueous electrolyte secondary battery 11 according to this embodiment are each described below.

### [Positive Electrode]

The positive electrode includes a positive electrode current collector that is a metal foil or the like and a positive electrode active material layer disposed on the positive electrode current collector. The positive electrode current collector is, for example, a foil made of a metal that is stable within the range of the potential of the positive electrode, such as aluminum, or a film including a surface layer made of such a metal. The positive electrode mixture layer preferably includes, in addition to the positive electrode active material, a conductant agent and a binder. The positive electrode may be formed by, for example, applying a positive electrode mixture slurry including the positive electrode active material, the conductant agent, the binder, and the like to the positive electrode current collector, drying the resulting coating film, and subsequently performing rolling such that a positive electrode mixture layer is formed on each of the surfaces of the current collector.

The conductant agent is used for increasing the electric conductivity of the positive electrode active material layer. Examples of the conductant agent include carbon materials such as carbon black, acetylene black, Ketjenblack, and graphite. The above conductant agents may be used alone or in combination of two or more.

The binder is used for maintaining the positive electrode active material and the conductant agent to be in intimate contact with each other and enhancing the capabilities of the positive electrode active material and the like to bind onto the surface of the positive electrode current collector. Examples of the binder include fluororesins such as polytetrafluoroethylene (PTFE) and polyvinylidene fluoride (PVdF), polyacrylonitrile (PAN), polyimide resins, acrylic resins, and polyolefin resins. The above resins may be used in combination with carboxymethyl cellulose (CMC), a salt thereof (e.g., CMC-Na, CMC-K, or CMC-NH₄; the salt may be formed by partial neutralization), polyethylene oxide (PEO), or the like. The above binders may be used alone or in combination of two or more.

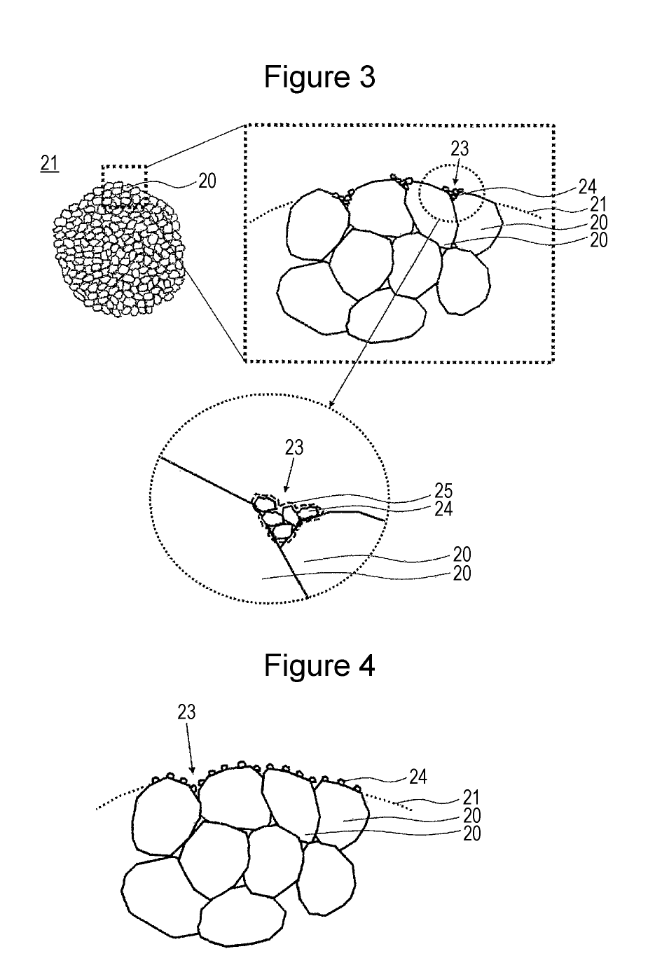

Particles of a positive electrode active material according to an exemplary embodiment are described below in detail with reference to FIG. 3. FIG. 3 includes a schematic cross-sectional view of a particle of the positive electrode active material according to the exemplary embodiment and magnified schematic cross-sectional views of a part of the particle of the positive electrode active material.

As illustrated in FIG. 3, a particle of the positive electrode active material includes a secondary particle 21 of a lithium transition metal oxide which is formed by the coagulation of primary particles 20 of the lithium transition metal oxide and secondary particles 25 of a rare earth compound which are each formed by the coagulation of primary particles 24 of the rare earth compound. The secondary particles 25 of the rare earth compound are each deposited on a groove 23 between a pair of adjacent primary particles 20 of the lithium transition metal oxide, the groove being formed in the surface of the secondary particle 21 of the lithium transition metal oxide, so as to come into contact with both of the pair of adjacent primary particles 20 in the groove 23.

The expression that the secondary particles 25 of the rare earth compound are each deposited so as to come into contact with both of the pair of adjacent primary particles 20 in the groove 23 means that, “in a cross section of the particle of the lithium transition metal oxide”, the secondary particles 25 of the rare earth compound each come into contact with both of the surfaces of the pair of adjacent primary particles 20 of the lithium transition metal oxide in the groove 23 between the pair of the primary particles 20 of the lithium transition metal, the groove being formed on the surface of the secondary particle 21 of the lithium transition metal oxide. While some of the secondary particles 25 of the rare earth compound may be deposited on a portion of the surface of the secondary particle 21 which is other than the groove 23, most of the secondary particles 25, that is, for example, 80% or more, 90% or more, or substantially 100% of the particles, are present in the groove 23.

In particles of the positive electrode active material according to this embodiment, the secondary particles 25 of the rare earth compound, which are each deposited on the groove 23 so as to come into contact with both of the pair of adjacent primary particles 20 of the lithium transition metal oxide, may reduce the degradation of the surfaces of the pair of adjacent primary particles 20 of the lithium transition metal oxide which occurs during cycles of charging and discharging and the occurrence of cracking at the interface between the pair of the primary particles in the groove 23. It is considered that the secondary particles 25 of the rare earth compound also fix (bond) the pair of adjacent primary particles 20 of the lithium transition metal oxide to each other. This may reduce the occurrence of cracking at the interface between the pair of the primary particles in the groove 23 even when the positive electrode active material is repeatedly expanded and shrunken during cycles of charging and discharging.

Furthermore, lithium difluorophosphate included in the nonaqueous electrolyte forms a good-quality film selectively on the groove 23, on which the rare earth compound is deposited. The good-quality film reduces the likelihood of the groove 23 and the electrolyte coming into contact with each other. This may further reduce the surface degradation which occurs at the interface between the primary particles in the groove 23. The good-quality film also reduces the degradation of the rare earth compound deposited on the groove 23. This may limit the degradation of the capability of the secondary particles 25 of the rare earth compound to fix (bond) the primary particles 20 of the lithium transition metal oxide to each other.

The reductions in the degradation of the surfaces of particles of the positive electrode active material which occurs during cycles of charging and discharging and the occurrence of cracking may result in, for example, a limitation of an increase in the contact resistance between the primary particles 20 of the lithium transition metal oxide. Moreover, the decomposition of the nonaqueous electrolyte may be reduced. This may limit, for example, an increase in the interface resistance between the particles of the positive electrode active material and the nonaqueous electrolyte. As a result, an increase in DCR which occurs during cycles of charging and discharging have been performed may be limited.

The rare earth compound used in this embodiment is preferably at least one compound selected from hydroxides, oxyhydroxides, oxides, carbonates, phosphates, and fluorides of rare earth elements and is particularly preferably at least one compound selected from hydroxides and oxyhydroxides of rare earth elements. Using the above rare earth compounds further reduces, for example, the surface degradation that occurs at the interface between the primary particles.

A rare earth element included in the rare earth compound is at least one element selected from scandium, yttrium, lanthanum, cerium, praseodymium, neodymium, samarium, europium, gadolinium, terbium, dysprosium, holmium, erbium, thulium, ytterbium, and lutetium. Among the above elements, neodymium, samarium, and erbium are particularly preferable. Compounds of neodymium, samarium, or erbium further reduces, for example, the surface degradation that occurs at the interface between the primary particles compared with other rare earth compounds.

Specific examples of the rare earth compound include hydroxides and oxyhydroxides, such as neodymium hydroxide, neodymium oxyhydroxide, samarium hydroxide, samarium oxyhydroxide, erbium hydroxide, and erbium oxyhydroxide; phosphates and carbonates, such as neodymium phosphate, samarium phosphate, erbium phosphate, neodymium carbonate, samarium carbonate, and erbium carbonate; and oxides and fluorides, such as neodymium oxide, samarium oxide, erbium oxide, neodymium fluoride, samarium fluoride, and erbium fluoride.

The average diameter of primary particles of the rare earth compound is preferably 5 nm or more and 100 nm or less and is more preferably 5 nm or more and 80 nm or less. The average diameter of secondary particles of the rare earth compound is preferably 100 nm or more and 400 nm or less and is more preferably 150 nm or more and 300 nm or less. If the average particle diameter exceeds 400 nm, the diameters of secondary particles of the rare earth compound are excessively large. This may reduce the number of grooves of the lithium transition metal oxide on which the secondary particles of the rare earth compound are deposited. In such a case, a large number of grooves of the lithium transition metal oxide fail to be protected by secondary particles of the rare earth compound, and it may become impossible to limit a reduction in the percentage at which the capacity is maintained after high-temperature cycles. If the average particle diameter is less than 100 nm, the area of portions at which each of the secondary particles of the rare earth compound comes into contact with both of a pair of adjacent primary particles of the lithium transition metal oxide is reduced. Accordingly, the capability to fix (bond) the pair of adjacent primary particles of the lithium transition metal oxide to each other is degraded. This may limit the reduction in the occurrence of cracking at the interface between the primary particles of the lithium transition metal oxide on the surface of the secondary particles of the lithium transition metal oxide.

The ratio of the amount of the rare earth compound (the amount of the rare earth compound deposited) to the total mass of the lithium transition metal oxide is preferably 0.005% by mass or more and 0.5% by mass or less and is more preferably 0.05% by mass or more and 0.3% by mass or less in terms of the amount of rare earth element. If the above ratio is less than 0.005% by mass, the amount of rare earth compound deposited on the grooves between the primary particles of the lithium transition metal oxide is small, and the above-described advantageous effect of the rare earth compound may be degraded. If the above ratio exceeds 0.5% by mass, not only the portions between the primary particles of the lithium transition metal oxide but also the surfaces of the secondary particles of the lithium transition metal oxide may be excessively covered with the rare earth compound. This may degrade the initial charge-discharge characteristics.

The average diameter of primary particles of the lithium transition metal oxide is preferably 100 nm or more and 5 μm or less and is more preferably 300 nm or more and 2 μm or less. If the average particle diameter is less than 100 nm, the amount of the interfaces between the primary particles, which includes the amount of the interfaces that are present inside the secondary particle, is excessively large. This may increase the likelihood of the primary particles cracking when the positive electrode active material is expanded and shrunken during cycles of charging and discharging. If the average particle diameter exceeds 5 μm, the amount of the interfaces between the primary particles, which includes the amount of the interfaces that are present inside the secondary particle, is excessively small. This may reduce the output particularly at low temperatures. The average diameter of secondary particles of the lithium transition metal oxide is preferably 2 μm or more and 40 μm or less and is more preferably 4 μm or more and 20 μm or less. If the average particle diameter is less than 2 μm, the sizes of the secondary particles are excessively small. Accordingly, the packing density of the positive electrode active material may be reduced, and it may become impossible to increase the capacity to a sufficient degree. If the average particle diameter exceeds 40 μm, a sufficiently high output may fail to be achieved particularly at low temperatures. Secondary particles of the lithium transition metal oxide, which are each formed by the binding (coagulation) of primary particles of the lithium transition metal oxide, are always larger than the primary particles.

The average diameters of the above particles are each determined by observing the surface and cross section of an active material particle with a scanning electron microscope (SEM) and measuring, for example, the diameters of several tens of particles. The average diameter of primary particles of the rare earth compound is measured in a direction along the surface of the active material but not in the thickness direction.

The ratio of the amount of nickel (Ni) included in the lithium transition metal oxide to the total number of moles of metal elements included in the lithium transition metal oxide which are other than lithium (Li) is preferably 80 mol % or more. This enables, for example, the capacity of the positive electrode to be increased and the occurrence of a proton-exchange reaction at the interfaces between the primary particles, which is described below, to be increased. Specific examples of the lithium transition metal oxide include lithium-containing nickel manganese composite oxide, lithium-containing nickel cobalt manganese composite oxide, lithium-containing nickel cobalt composite oxide, and lithium-containing nickel cobalt aluminum composite oxide. The molar ratio between nickel, cobalt, and aluminum included in the lithium-containing nickel cobalt aluminum composite oxide may be, for example, 8:1:1, 82:15:3, 85:12:3, 87:10:3, 88:9:3, 88:10:2, 89:8:3, 90:7:3, 91:6:3, 91:7:2, 92:5:3, or 94:3:3. The above lithium transition metal oxides may be used alone or in a mixture.

In a lithium transition metal oxide having a Ni ratio (Ni proportion) of 80 mol % or more, the proportion of trivalent Ni is large. This increases the occurrence of a proton-exchange reaction between water and lithium included in the lithium transition metal oxide in water. LiOH produced by the proton-exchange reaction migrates from the inside of each interface between primary particles of the lithium transition metal oxide to the surface of the secondary particle. This makes the alkali (OH⁻) concentration in a gap between a pair of adjacent primary particles of the lithium transition metal oxide on the surface of the secondary particle of the lithium transition metal oxide to be higher than the alkali concentration in the vicinities of the gap. This increases the likelihood of primary particles of the rare earth compound being deposited on the groove between the primary particles while being coagulated with one another to form secondary particles by being attracted by the alkali present in the groove. In contrast, in a lithium transition metal composite oxide having a Ni ratio of less than 80 mol %, the proportion of trivalent Ni is small and the above proton-exchange reaction is not likely to occur. Thus, the alkali concentration in a gap between each pair of adjacent primary particles of the lithium transition metal oxide does not differ from the alkali concentration in the vicinity of the gap. Consequently, when secondary particles of the rare earth compound formed by the binding of the precipitated primary particles of the rare earth compound adhere to the surface of the lithium transition metal oxide, they are likely to adhere to protrusions of primary particles of the lithium transition metal oxide, to which the secondary particles of the rare earth compound are more likely to come into collision.

The ratio of the amount of cobalt (Co) included in the lithium transition metal oxide to the total number of moles of metal elements included in the lithium transition metal oxide which are other than Li is preferably 7 mol % or less and is more preferably 5 mol % or less in order to, for example, increase the capacity. If the amount of cobalt is excessively small, the structure is likely to change during charging and discharging, which may increase the occurrence of cracking at the interfaces between particles. This further limits the surface degradation.

The lithium transition metal oxide may further include other additional elements. Examples of the additional elements include boron (B), aluminum (Al), titanium (Ti), chromium (Cr), iron (Fe), copper (Cu), zinc (Zn), niobium (Nb), molybdenum (Mo), tantalum (Ta), tungsten (W), zirconium (Zr), tin (Sn), sodium (Na), potassium (K), barium (Ba), strontium (Sr), calcium (Ca), bismuth (Bi), and germanium (Ge).

It is preferable to remove alkali components deposited on the surface of the lithium transition metal oxide by washing the lithium transition metal oxide with water or the like in order to, for example, produce a battery having a high-temperature storage property.

One of methods for depositing the rare earth compound on the surfaces of secondary particles of the lithium transition metal oxide is to add an aqueous solution including the rare earth compound dissolved therein to a suspension including the lithium transition metal oxide.

In order to deposit the rare earth compound on the surfaces of secondary particles of the lithium transition metal oxide, it is desirable to adjust the pH of the suspension to 11.5 or more and preferably 12 or more while the aqueous solution, in which the compound containing a rare earth element is dissolved, is added to the suspension. This is because performing the treatment under the above condition increases the likelihood of particles of the rare earth compound being locally deposited on the surfaces of the secondary particles of the lithium transition metal oxide. In contrast, if the pH of the suspension is set to 6 or more and 10 or less, particles of the rare earth compound are likely to be deposited uniformly over the entire surfaces of secondary particles of the lithium transition metal oxide. This may result in failure to sufficiently reduce the occurrence of cracking in the active material which may be caused due to the surface degradation at the interfaces of primary particles of the lithium transition metal oxide on the surfaces of the secondary particles of the lithium transition metal oxide. If the pH is less than 6, at least part of the lithium transition metal oxide may be dissolved.

It is desirable to adjust the pH of the suspension to be 14 or less or preferably 13 or less. If the pH exceeds 14, the size of primary particles of the rare earth compound becomes excessively large. In addition, an excessive amount of alkali remains inside the particles of the lithium transition metal oxide. This may increase the occurrence of gelation in the preparation of the slurry and cause an excessive amount of gas to be generated while the battery is stored.

When the aqueous solution including the rare earth compound dissolved therein is added to the suspension including the lithium transition metal oxide, a hydroxide of the rare earth element is precipitated in the case where the aqueous solution is directly used. In another case where a sufficient amount of carbon dioxide has been dissolved, a carbonate of the rare earth element is precipitated. In the case where a sufficient amount of phosphate ions have been added to the suspension, the rare earth compound is precipitated on the surfaces of particles of the lithium transition metal oxide in the form of a phosphate of the rare earth element. It is also possible to form a rare earth compound including, for example, a hydroxide and a fluoride in a mixed manner by controlling the types of ions dissolved in the suspension.

The particles of the lithium transition metal oxide on which the rare earth compound is precipitated are preferably subjected to a heat treatment. The heat treatment is preferably performed at 80° C. or more and 500° C. or less and particularly preferably at 80° C. or more and 400° C. or less. If the heat-treatment temperature is less than 80° C., an excessively large amount of time may be required for sufficiently drying the positive electrode active material by the heat treatment. If the heat-treatment temperature exceeds 500° C., a portion of the rare earth compound deposited on the surfaces of the particles of the lithium transition metal oxide may diffuse inside the particles. As a result, the occurrence of surface degradation at the interfaces between the primary particles of the lithium transition metal oxide may fail to be sufficiently reduced. In contrast, when the heat-treatment temperature is 400° C. or less, the rare earth element hardly diffuses inside the particles of the lithium transition metal composite oxide and strongly adheres to the interfaces between the primary particles. This enhances, for example, a reduction in the occurrence of surface degradation at the interfaces between the primary particles of the lithium transition metal oxide and the capability to bond the primary particles to one another. In the case where a hydroxide of the rare earth element is deposited at the interfaces between the primary particles, most of the hydroxide is changed into an oxyhydroxide at about 200° C. to about 300° C. Most of the oxyhydroxide is further changed into an oxide at about 450° C. to about 500° C. Accordingly, when the heat treatment is performed at 400° C. or less, it is possible to dispose a hydroxide or an oxyhydroxide of the rare earth element, which is capable of markedly reducing the occurrence of the surface degradation, selectively at the interfaces between the primary particles of the lithium transition metal oxide. This further limits an increase in DCR which occurs during cycles of charging and discharging have been performed.

The heat treatment of the lithium transition metal oxide on which the rare earth compound is deposited is preferably performed in vacuum. If the heat treatment is not performed in vacuum, the moisture contained in the suspension used for the deposition of the rare earth compound, which is permeated inside particles of the lithium transition metal oxide, may fail to be efficiently removed because the secondary particles of the rare earth compound deposited on the grooves between the primary particles which are formed on the surfaces of secondary particles of the lithium transition metal oxide make it difficult to remove the moisture from the inside of the particles when the particles are dried. If the amount of moisture that migrates from the positive electrode active material into the battery is increased, the moisture reacts with the nonaqueous electrolyte, and the reaction product may degrade the surface of the active material.

The aqueous solution including the rare earth compound may be prepared by dissolving an acetic acid salt, a nitric acid salt, a sulfuric acid salt, an oxide, a chloride, or the like in water or an organic solvent. An aqueous solution prepared by dissolving the above compound in water is preferably used because, for example, it has high solubility. In particular, when an oxide of a rare earth element is used, the aqueous solution may be prepared by dissolving the rare earth element in an acid such as sulfuric acid, hydrochloric acid, nitric acid, or acetic acid and dissolving the resulting sulfuric acid salt, chloride, or nitric acid salt of the rare earth element in water.

If the rare earth compound is deposited on the surfaces of secondary particles of the lithium transition metal oxide by a method in which the lithium transition metal oxide and the rare earth compound are mixed with each other by a dry process, particles of the rare earth compound adhere onto the surfaces of the secondary particles of the lithium transition metal oxide at random and it is difficult to deposit the rare earth compound selectively at the interfaces between the primary particles which are present on the surfaces of the secondary particles. In addition, if the dry-mixing method is employed, it is difficult to firmly deposit the rare earth compound on the lithium transition metal oxide. As a result, it may become impossible to sufficiently fix (bond) the primary particles to one another. Furthermore, the rare earth compound may become easily detached from the lithium transition metal oxide when the active material is mixed with the conductant agent, the binder, and the like to form a positive electrode mixture.

The positive electrode active material is not limited to that including only the particles of the lithium transition metal oxide according to the above-described embodiment; it is also possible to use the lithium transition metal oxide according to the above-described embodiment in combination with another positive electrode active material. The other positive electrode active material is not limited and may be any compound to which lithium ions can be inserted and from which lithium ions can be removed reversibly. Examples of such compound include compounds having a layered structure, such as lithium cobaltite and lithium nickel cobalt manganese oxide; compounds having a spinel structure, such as lithium manganese oxide and lithium nickel manganese oxide; and compounds having an olivine structure, to which lithium ions can be inserted and from which lithium ions can be removed while the stable crystal structure is maintained. In the case where only one type of positive electrode active material is used or different types of positive electrode active materials are used, the diameters of the particles of the positive electrode active material may be identical or different from one another.

### [Negative Electrode]

The negative electrode includes a negative electrode current collector made of a metal foil or the like and a negative electrode mixture layer disposed on the current collector. The negative electrode current collector is, for example, a foil made of a metal that is stable within the range of the potential of the negative electrode, such as copper, or a film including a surface layer made of the metal. The negative electrode mixture layer preferably includes, in addition to the negative electrode active material, a binder. The negative electrode may be formed by, for example, applying a negative electrode mixture slurry including the negative electrode active material, the binder, and the like to the negative electrode current collector, drying the resulting coating film, and subsequently performing rolling such that a negative electrode mixture layer is formed on each of the surfaces of the current collector.

The negative electrode active material is not limited and may be any material capable of occluding and releasing lithium ions reversibly. Examples of such a material include carbon materials such as natural graphite and synthetic graphite; metals that can be alloyed with lithium, such as silicon (Si) and tin (Sn); and alloys and composite oxides that include the metal element such as Si or Sn. The above negative electrode active materials may be used alone or in combination of two or more.

Examples of the binder include fluororesins, PAN, polyimide resin, acrylic resins, and polyolefin resins as in the case of the positive electrode. In the case where the mixture slurry is prepared with an aqueous solvent, CMC, a salt thereof (e.g., CMC-Na, CMC-K, or CMC-NH₄; the salt may be formed by partial neutralization), a styrene-butadiene rubber (SBR), polyacrylic acid (PAA), a salt thereof (e.g., PAA-Na or PAA-K; the salt may be formed by partial neutralization), polyvinyl alcohol (PVA), and the like are preferably used.

### [Separator]

The separator may be a porous sheet having ion permeability and an insulating property. Specific examples of the porous sheet include a microporous thin film, woven fabric, and nonwoven fabric. The separator is preferably composed of a polyolefin resin such as polyethylene or polypropylene, cellulose, or the like. The separator may be a multilayer body including a cellulose fiber layer and a thermoplastic resin fiber layer composed of a polyolefin resin or the like. The separator may also be a multilayer separator including a polyethylene layer and a polypropylene layer. An aramid resin or the like may optionally be applied onto the surface of the separator.

A filler layer including an inorganic filler may optionally be interposed between the separator and at least one of the positive electrode and the negative electrode. Examples of the inorganic filler include oxides and phosphates that contain at least one element selected from titanium (Ti), aluminum (Al), silicon (Si), and magnesium (Mg). The surfaces of the above inorganic fillers may be treated with a hydroxide or the like. For forming the filler layer, for example, a slurry including the filler is applied onto the surface of the positive electrode, the negative electrode, or the separator.

### [Nonaqueous Electrolyte]

The nonaqueous electrolyte includes a nonaqueous solvent and a solute dissolved in the nonaqueous solvent. Examples of the nonaqueous solvent include esters, ethers, nitriles, amides such as dimethylformamide, isocyanates such as hexamethylene diisocyanate, and mixed solvents that include two or more of the above solvents. The nonaqueous solvent may include a halogen-substituted substance formed by replacing at least some of hydrogen atoms included in one of the above solvents with halogen atoms such as fluorine atoms.

Examples of the esters include cyclic carbonic acid esters, such as ethylene carbonate (EC), propylene carbonate (PC), and butylene carbonate; chain carbonic acid esters, such as dimethyl carbonate (DMC), methyl ethyl carbonate (EMC), diethyl carbonate (DEC), methyl propyl carbonate, ethyl propyl carbonate, and methyl isopropyl carbonate; cyclic carboxylic acid esters, such as γ-butyrolactone and γ-valerolactone; and chain carboxylic acid esters, such as methyl acetate, ethyl acetate, propyl acetate, methyl propionate (MP), and ethyl propionate.

Examples of the ethers include cyclic ethers such as 1,3-dioxolane, 4-methyl-1,3-dioxolane, tetrahydrofuran, 2-methyltetrahydrofuran, propylene oxide, 1,2-butylene oxide, 1,3-dioxane, 1,4-dioxane, 1,3,5-trioxane, furan, 2-methylfuran, 1,8-cineole, and crown ethers; and chain ethers such as 1,2-dimethoxyethane, diethyl ether, dipropyl ether, diisopropyl ether, dibutyl ether, dihexyl ether, ethyl vinyl ether, butyl vinyl ether, methyl phenyl ether, ethyl phenyl ether, butyl phenyl ether, pentyl phenyl ether, methoxytoluene, benzyl ethyl ether, diphenyl ether, dibenzyl ether, o-dimethoxybenzene, 1,2-diethoxyethane, 1,2-dibutoxyethane, diethylene glycol dimethyl ether, diethylene glycol diethyl ether, diethylene glycol dibutyl ether, 1,1-dimethoxymethane, 1,1-diethoxyethane, triethylene glycol dimethyl ether, and tetraethylene glycol dimethyl.

Examples of the nitriles include acetonitrile, propionitrile, butyronitrile, valeronitrile, n-heptanitrile, succinonitrile, glutaronitrile, adiponitrile, pimelonitrile, 1,2,3-propanetricarbonitrile, and 1,3,5-pentanetricarbonitrile.

The halogen-substituted substance is preferably, for example, a fluorinated cyclic carbonic acid ester such as fluoroethylene carbonate (FEC); a fluorinated chain carbonic acid ester; or a fluorinated chain carboxylic acid ester such as fluoro methylpropionate (FMP).

The nonaqueous electrolyte includes lithium difluorophosphate dissolved in the nonaqueous solvent as a solute. Lithium difluorophosphate forms a good-quality film in the grooves of the lithium transition metal oxide, which further reduces the occurrence of the surface degradation at the grooves and limits the degradation of the rare earth compound deposited on the grooves. The concentration of lithium difluorophosphate included in the nonaqueous electrolyte is preferably 0.01 M or more and 0.25 M or less and is more preferably 0.05 M or more and 0.20 M or less. If the concentration is less than 0.01 M, the amount of the film originating from lithium difluorophosphate is small and the above advantageous effects may fail to be achieved. If the concentration is 0.25 M or more, an excessively thick film may be formed. This increases the resistance of the battery and, as a result, reduces the output of the battery.

Solutes that have been used in the related art may be used in combination with lithium difluorophosphate. Examples of such solutes include fluorine-containing lithium salts such as LiPF₆, LiBF₄, LiCF₃SO₃, LiN(FSO₂)₂, LiN(CF₃SO₂)₂, LiN(C₂F₅SO₂)₂, LiN(CF₃SO₂) (C₄F₉SO₂), LiC(C₂F₅SO₂)₃, and LiAsF₆. A lithium salt other than a fluorine-containing lithium salt [lithium salt containing one or more elements selected from P, B, O, S, N, and Cl (e.g., LiClO₄)] may be added to the fluorine-containing lithium salt. The solute preferably includes the fluorine-containing lithium salt and a lithium salt including an oxalate complex serving as an anion in order to form a stable film on the surface of the negative electrode even under a high-temperature environment.

Examples of the lithium salt including an oxalate complex serving as an anion include LiBOB [lithium-bisoxalateborate], Li[B(C₂O₄)F₂], Li[P(C₂O₄)F₄], and Li[P(C₂O₄)₂F₂]. Among the above lithium salts, LiBOB, which enables a particularly stable film to be formed on the negative electrode, is preferably used. The above solutes may be used alone or in a mixture of two or more.

The nonaqueous electrolyte may include an overcharge inhibitor, such as cyclohexylbenzene (CHB). Other examples of the overcharge inhibitor include alkylbiphenyls such as biphenyl and 2-methylbiphenyl; terphenyls; partially hydrogenated terphenyls; naphthalene; benzene derivatives such as toluene, anisole, cyclopentylbenzene, t-butylbenzene, and t-amylbenzene; phenyl ether derivatives such as phenyl propionate and 3-phenylpropyl acetate; halides thereof; and halogenated benzenes such as fluorobenzene and chlorobenzene. The above overcharge inhibitors may be used alone or in a mixture of two or more.

TEST EXAMPLES

The present invention is further described below with reference to Test Examples. The present invention is not limited by Test Examples below.

### First Test Examples

### Test Example 1

### [Preparation of Positive Electrode Active Material]

LiOH and an oxide prepared by heating nickel cobalt aluminum composite hydroxide represented by Ni_{0.91}Co_{0.06}Al_{0.03}(OH)₂, which was formed by coprecipitation, at 500° C. were mixed together using an Ishikawa automated mortar such that the molar ratio between Li and all transition metals was 1.05:1. The resulting mixture was subjected to a heat treatment at 760° C. for 20 hours in an oxygen atmosphere and subsequently pulverized. Thus, particles of a lithium nickel cobalt aluminum composite oxide (the lithium transition metal oxide) represented by Li_{1.05}Ni_{0.91}Co_{0.06}Al_{0.03}O₂ were prepared. The average diameter of secondary particles of the lithium transition metal oxide was about 15 μm.

To 1.5 L of pure water, 1000 g of particles of the lithium transition metal oxide were added. The resulting mixture was stirred to form a suspension including the lithium transition metal oxide dispersed in pure water. To the suspension, a 0.1-mol/L aqueous erbium sulfate solution, which was prepared by dissolving erbium oxide in sulfuric acid, was added incrementally in small amounts. While the aqueous erbium sulfate solution was added to the suspension, the pH of the suspension was 11.5 to 12.0. Subsequently, the suspension was filtered. The resulting powder was washed with pure water and then dried at 200° C. in vacuum. Thus, a positive electrode active material was prepared.

An observation of the surface of the positive electrode active material with a scanning electron microscope (SEM) confirmed that secondary particles of erbium hydroxide having an average diameter of 100 to 200 nm, which were formed by the coagulation of primary particles of erbium hydroxide having an average diameter of 20 to 30 nm, were deposited on the surfaces of secondary particles of the lithium transition metal oxide. It was also confirmed that most of the secondary particles of erbium hydroxide were each deposited on a groove between a pair of adjacent primary particles of the lithium transition metal oxide which was formed in the surfaces of secondary particles of the lithium transition metal oxide so as to come into contact with both of the pair of the primary particles in the groove. The amount of erbium compound deposited on the lithium transition metal oxide which was measured by inductively coupled plasma (ICP)-atomic emission spectroscopy was 0.15% by mass of the amount of lithium nickel cobalt aluminum composite oxide in terms of the amount of erbium.

It is considered that, in Test Example 1, where the pH of the suspension was high (11.5 to 12.0), primary particles of erbium hydroxide precipitated in the suspension were joined to (coagulated with) one another to form secondary particles. Furthermore, in Test Example 1, where the proportion of Ni was high (91%), and the proportion of trivalent Ni was large, a proton-exchange reaction between LiNiO₂ and H₂O was likely to occur at the interfaces between primary particles of the lithium transition metal oxide, and a large amount of LiOH generated by the proton-exchange reaction migrated from the inside of the secondary particles of the lithium transition metal oxide at the interfaces between adjacent primary particles of the lithium transition metal oxide. This increased the alkali concentration in a gap between each pair of adjacent primary particles which was formed in the surface of the lithium transition metal oxide. As a result, the particles of erbium hydroxide were precipitated in the suspension while being coagulated with one another at the grooves formed in the interfaces between the primary particles to form secondary particles by being attracted by the alkali.

### [Preparation of Positive Electrode]

The particles of the positive electrode active material, carbon black, and an N-methyl-2-pyrrolidone solution of polyvinylidene fluoride were weighed such that the mass ratio between the particles of the positive electrode active material, the conductant agent, and the binder was 100:1:1. The above materials were mixed together while being kneaded with a T.K. HIVIS MIX (produced by PRIMIX Corporation) to form a positive electrode mixture slurry.

The positive electrode mixture slurry was applied onto both surfaces of a positive electrode current collector that was an aluminum foil. After the resulting coating film had been dried, rolling was performed with a reduction roller. A current collector tab made of aluminum was attached to the resulting current collector. Thus, a positive electrode plate including a positive electrode current collector and two positive electrode mixture layers disposed on the respective surfaces of the current collector was prepared. The packing density of the positive electrode active material in the positive electrode was 3.60 g/cm³.

### [Preparation of Negative Electrode]

Synthetic graphite, which served as a negative electrode active material, was mixed with CMC (sodium carboxymethyl cellulose) and a SBR (styrene-butadiene rubber) in an aqueous solution such that the mass ratio between the negative electrode active material, CMC, and the SBR was 100:1:1 in order to prepare a negative electrode mixture slurry. The negative electrode mixture slurry was uniformly applied onto both surfaces of a negative electrode current collector that was a copper foil. After the resulting coating film had been dried, rolling was performed with a reduction roller. A current collector tab made of nickel was attached to the resulting current collector. Thus, a negative electrode plate including a negative electrode current collector and two negative electrode mixture layers disposed on the respective surfaces of the current collector was prepared. The packing density of the negative electrode active material in the negative electrode was 1.75 g/cm³.

### [Preparation of Nonaqueous Electrolyte Solution]

Lithium hexafluorophosphate (LiPF₆) was dissolved in a mixed solvent including ethylene carbonate (EC), methyl ethyl carbonate (MEC), and dimethyl carbonate (DMC) at a volume ratio of 2:2:6 such that the concentration of LiPF₆ in the mixed solvent was 1.3 mol/L. Vinylene carbonate (VC) was dissolved in the mixed solvent such that the concentration of VC in the mixed solvent was 2.0% by mass. Lithium difluorophosphate was further dissolved in the mixed solvent such that the concentration of lithium difluorophosphate in the mixed solvent was 0.07 mol/L. Thus, a nonaqueous electrolyte solution was prepared.

### [Preparation of Battery]

The positive electrode and the negative electrode were stacked on each other with a separator interposed between the electrodes. After the resulting multilayer body had been wound into a spiral form, the core used for winding the multilayer body was removed. Thus, a spiral electrode body was prepared. The spiral electrode body was pressed to form a flat electrode body. The flat electrode body and the nonaqueous electrolyte solution were charged into a case laminated with aluminum. Thus a battery A1 was prepared. The size of the battery was 3.6 mm thick, 35 mm wide, and 62 mm long. The discharging capacity of the nonaqueous electrolyte secondary battery which was measured by charging the battery to 4.20 V and subsequently discharging the battery to 3.0 V was 950 mAh.

### Test Example 2

A battery A2 was prepared as in Test Example 1 above, except that lithium difluorophosphate was not used in the preparation of the nonaqueous electrolyte solution.

### Test Example 3

A positive electrode active material was prepared as in Test Example 1 above, except that, in the preparation of the positive electrode active material, the pH of the suspension was consistently maintained to be 9 while the aqueous erbium sulfate solution was added to the suspension. A battery A3 was prepared using the positive electrode active material. For adjusting the pH of the suspension to be 9, a 10-mass % aqueous sodium hydroxide solution was used as needed.

An observation of the surface of the positive electrode active material with a SEM confirmed that primary particles of erbium hydroxide having an average diameter of 10 to 50 nm were deposited on the surfaces of secondary particles of the lithium transition metal oxide so as to uniformly disperse over the entire surfaces (including protrusions and grooves) of the secondary particles of the lithium transition metal oxide without forming secondary particles. The amount of erbium compound deposited on the lithium transition metal oxide which was measured by inductively coupled plasma (ICP)-atomic emission spectroscopy was 0.15% by mass of the amount of lithium nickel cobalt aluminum composite oxide in terms of the amount of erbium.

It is considered that, in Test Example 3, where the pH of the suspension was 9, the rate at which particles of erbium hydroxide were precipitated in the suspension was low. This caused the particles of erbium hydroxide to uniformly precipitate over the entire surfaces of the secondary particles of the lithium transition metal oxide without forming secondary particles.

### Test Example 4

A battery A4 was prepared as in Test Example 3 above, except that lithium difluorophosphate was not used in the preparation of the nonaqueous electrolyte solution.

### Test Example 5

A positive electrode active material was prepared as in Test Example 1 above, except that, in the preparation of the positive electrode active material, as a result of omitting the addition of the aqueous erbium sulfate solution, erbium hydroxide was not deposited onto the surfaces of secondary particles of the lithium transition metal oxide. A battery A5 was prepared using the positive electrode active material.

### Test Example 6

A battery A6 was prepared as in Test Example 5 above, except that lithium difluorophosphate was not used in the preparation of the nonaqueous electrolyte solution.

### [Measurement of DCR]

The DCR of each of the batteries A1 to A6 prepared as described above was measured under the following conditions before and after 100 cycles of charging and discharging had been performed.

<Measurement of DCR before Cycles>

The battery was charged at 475 mA until the SOC reached 100% and subsequently charged at a constant voltage equal to the voltage of the battery at which the SOC reached 100% until the current reached 30 mA. The open circuit voltage (OCV) of the battery was measured after an interval of 120 minutes since the charging of the battery had finished. Subsequently, the battery was discharged at 475 mA for 0.5 seconds. The voltage of the battery was measured subsequent to the 0.5-second discharging. The DCR (SOC: 100%) of the battery that had not been subjected to the cycles was determined using Formula (1) below.

DCR (Ω)=(OCV after 120-minute interval (V)−voltage after 0.5-second discharging (V))/(current (A)) (1)

The battery was subjected to 100 cycles of charging and discharging. The term “cycle of charging and discharging” used herein refers to charging and discharging performed under the following conditions.

### <Charge-Discharge Cycle Test>

Charging Conditions

The battery was charged at a constant current of 475 mA until the voltage of the battery reached 4.2 V (potential of positive electrode with reference to lithium: 4.3 V). After the voltage of the battery had reached 4.2 V, the battery was charged at a constant voltage of 4.2 V until the current reached 30 mA.

Discharging Conditions

The battery was discharged at a constant current of 950 mA until the voltage of the battery reached 3.0 V.

Interval Conditions

The interval between each charging and corresponding discharging was set to 10 minutes.

<Measurement of DCR after 100 Cycles>

The DCR of the battery that had been subjected to the 100 cycles was measured as in the measurement of DCR before the cycles described above. The interval between each charge-discharge cycle test and corresponding measurement of DCR after cycles was set to 10 minutes. The measurement of DCR and the charge-discharge cycle test were conducted in a thermostat kept at 25° C.

### [Calculation of Increase in DCR]

An increase in the DCR of the battery which occurred after the battery had been subjected to the 100 cycles was calculated using Formula (2) below. Table 1 show the results.

Increase in DCR (SOC: 100%)=(DCR (SOC: 100%) after 100 cycles/(DCR (SOC: 100%) before cycles×100 (2)

TABLE 1

| | | | Concentration of | |
|---|---|---|---|---|
| | | | lithium | |
| | Rare earth | State of rare earth | difluorophosphate | Increase in |
| Battery | element | compound deposited | (M) | DCR (%) |
| A1 | Er | Coagulated in | 0.07 | 33 |
| | | grooves | | |
| A2 | Er | Coagulated in | 0 | 41 |
| | | grooves | | |
| A3 | Er | Uniformly dispersed | 0.07 | 44 |
| A4 | Er | Uniformly dispersed | 0 | 46 |
| A5 | None | — | 0.07 | 44 |
| A6 | None | — | 0 | 47 |

The battery A1 was examined as follows. In the positive electrode active material included in the battery A1, the secondary particles 25 of the rare earth compound were each deposited on both of a pair of adjacent primary particles 20 of the lithium transition metal oxide in the groove 23 as illustrated in FIG. 3. This presumably reduced the occurrence of degradation of the surfaces of the pair of the primary particles 20 and the occurrence of cracking at the interface between the primary particles 20 during the cycles of charging and discharging. Furthermore, the secondary particles 25 of the rare earth compound each enabled the pair of adjacent primary particles 20 of the lithium transition metal oxide to be fixed (bonded) to each other and reduced the occurrence of cracking at the interface between the primary particles in the groove 23.

In the battery A1, the secondary particle 25 of the rare earth compound deposited on both of the pair of adjacent primary particles 20 of the lithium transition metal oxide in the groove 23 attracted lithium difluorophosphate included in the electrolyte and increased the likelihood of a film originating from lithium difluorophosphate being formed in the vicinity of the groove 23. Formation of the film further reduced the likelihood of being in contact with the electrolyte and degradation of the deposited rare earth compound. This presumably reduced the surface degradation at the interface between the secondary particles and cracking at the interface between the primary particles.

That is, in the battery A1, the rare earth compound and the film originating from lithium difluorophosphate reduced the surface degradation of the positive electrode active material and the cracking in the positive electrode active material. The film originating from lithium difluorophosphate also reduced the degradation of the rare earth compound. It is considered that, accordingly, the increase in the DCR of the battery A1 which occurred after the battery A1 had been subjected to the cycles of charging and discharging was the smallest.

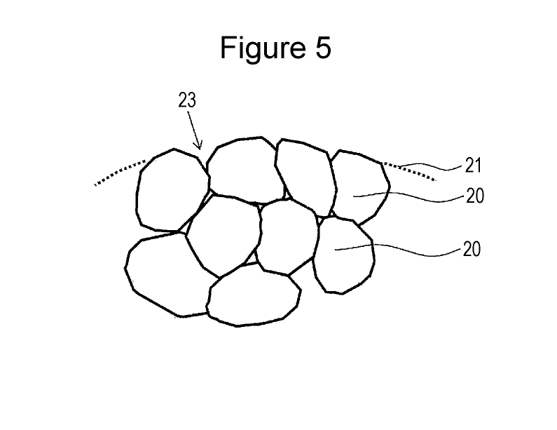

The batteries A3 and A5 were examined as follows. In the positive electrode active material used in the battery A3, the primary particles 24 of the rare earth compound were deposited uniformly over the entire surface of the secondary particle 21 of the lithium transition metal oxide without forming secondary particles as illustrated in FIG. 4. In the positive electrode active material used in the battery A5, the rare earth element was not deposited on the surface of the secondary particle 21 of the lithium transition metal oxide as illustrated in FIG. 5.

It is considered that, in the batteries A3 and A5, in which a secondary particle of the rare earth compound was not deposited on the groove 23 formed in the surface of the secondary particle 21 of the lithium transition metal oxide, it was not possible to reduce the degradation of the surfaces of the pair of adjacent primary particles 20 and the cracking in the interface between the pair of the primary particles 20. In the battery A3, in which the rare earth compound was deposited on the surface of the secondary particle so as to disperse uniformly over the surface of the secondary particle, a film originating from lithium difluorophosphate was formed substantially uniformly over the surface of the particle. Therefore, the amount of film formed in the groove was small compared with the battery A1. Specifically, in the battery A3, it was not possible to reduce the surface degradation in the groove 23 to a sufficient degree compared with the battery A1. This increased the occurrence of cracking at the interface between the primary particles. In the battery A5, in which the rare earth compound was not present, lithium difluorophosphate was less likely to be attracted toward the surface of the positive electrode active material than in the battery A1 or A3. Accordingly, the amount of film originating from lithium difluorophosphate which was formed in the groove of the surface of the positive electrode active material was further small. As described above, in the batteries A3 and A5, the secondary particle of the rare earth compound, which reduces the surface degradation and cracking, was not present in the groove and the amount of the film originating from lithium difluorophosphate, which reduces the likelihood of the reaction with the electrolyte, was smaller than in the battery A1. This presumably made the increases in the DCRs of the batteries A3 and A5 which occurred after the batteries had been subjected to the above cycles to be larger than that of the battery A1.

The batteries A2, A4, and A6 were examined as follows. The electrolytes included in the batteries A2, A4, and A6 were the same as those included in the batteries 1, 3, and 5, respectively, except that the electrolytes included in the batteries A2, A4, and A6 did not include lithium difluorophosphate.

In the battery A2, the secondary particle 25 of the rare earth compound was deposited on both of the pair of adjacent primary particles 20 of the lithium transition metal oxide in the groove 23. This presumably reduced the degradation of the surfaces of the pair of adjacent primary particles 20 and the cracking at the interface between the primary particles for the same reasons as in the battery A1. However, in the battery A2, in which the nonaqueous electrolyte did not include lithium difluorophosphate, the film originating from lithium difluorophosphate was not formed in the vicinity of the groove 23. The absence of the film made it impossible to reduce the degradation of secondary particles of the rare earth compound. This resulted in a reduction in the fixing strength during the cycles and made it impossible to sufficiently reduce the cracking in the interface between the primary particles. This presumably increased the resistance of the positive electrode and made the increase in the DCR of the battery A2 which occurred after the battery had been subjected to the cycles to be larger than that of the battery A1.

In the batteries A4 and A6, secondary particles of the rare earth compound were not deposited on the groove 23 formed in the surface of the secondary particle 21 of the lithium transition metal oxide. This made it impossible to reduce the degradation of the surfaces of the pair of adjacent primary particles 20 and the cracking in the interface between the primary particles 20. In addition, in the batteries A4 and A6, in which the nonaqueous electrolyte did not include lithium difluorophosphate, the film originating from lithium difluorophosphate was not formed in the vicinity of the groove 23. This presumably made the resistances of the positive electrodes of the batteries A4 and A6 to be higher than that of the battery A2 and the increases in the DCRs of the batteries A4 and A6 which occurred after the batteries had been subjected to the above cycles to be larger than that of the battery A2.

### Second Test Examples

While erbium was used as a rare earth element in First Test Examples, Second Test Examples discuss other cases where samarium or neodymium was used as a rare earth element.

### Test Example 7

A positive electrode active material was prepared as in Test Example 1 above, except that, in the preparation of the positive electrode active material, an aqueous samarium sulfate solution was used instead of the aqueous erbium sulfate solution. A battery A7 was prepared using the positive electrode active material. The amount of samarium compound deposited on the lithium transition metal oxide which was measured by inductively coupled plasma (ICP)-atomic emission spectroscopy was 0.13% by mass of the amount of lithium nickel cobalt aluminum composite oxide in terms of the amount of samarium.

### Test Example 8

A positive electrode active material was prepared as in Test Example 1 above, except that, in the preparation of the positive electrode active material, an aqueous neodymium sulfate solution was used instead of the aqueous erbium sulfate solution. A battery A8 was prepared using the positive electrode active material. The amount of neodymium compound deposited on the lithium transition metal oxide which was measured by inductively coupled plasma (ICP)-atomic emission spectroscopy was 0.13% by mass of the amount of lithium nickel cobalt aluminum composite oxide in terms of the amount of neodymium.

Increases in the DCRs of the batteries A7 and A8 which occurred after the batteries had been subjected to the 100 cycles were measured as in Test Example 1 above.

TABLE 2

| | | | Concentration of | |
|---|---|---|---|---|
| | | | lithium | |
| | Rare earth | State of rare earth | difluorophosphate | Increase in |
| Battery | element | compound deposited | (M) | DCR (%) |
| A1 | Er | Coagulated in | 0.07 | 33 |
| | | grooves | | |
| A7 | Sm | Coagulated in | 0.07 | 35 |
| | | grooves | | |
| A8 | Nd | Coagulated in | 0.07 | 35 |
| | | grooves | | |

The results shown in Table 2 confirm that it was also possible to limit an increase in DCR by using samarium or neodymium, which is also a rare earth element similarly to erbium. Thus, it is considered that using a rare earth element other than erbium, samarium, or neodymium may also limit an increase in DCR.

### REFERENCE SIGNS LIST

1 POSITIVE ELECTRODE, 2 NEGATIVE ELECTRODE, 3 SEPARATOR, 4 POSITIVE ELECTRODE CURRENT COLLECTOR TAB, 5 NEGATIVE ELECTRODE CURRENT COLLECTOR TAB, 6 ALUMINUM-LAMINATED CASE, 7 CLOSURE PORTION, 11 NONAQUEOUS ELECTROLYTE SECONDARY BATTERY, 20 PRIMARY PARTICLES OF LITHIUM TRANSITION METAL OXIDE, 21 SECONDARY PARTICLE OF LITHIUM TRANSITION METAL OXIDE, 24 PRIMARY PARTICLES OF RARE EARTH COMPOUND, 25 SECONDARY PARTICLE OF RARE EARTH COMPOUND, 23 GROOVE, 26 PROTRUSION

1. A nonaqueous electrolyte secondary battery comprising a positive electrode, a negative electrode, and a nonaqueous electrolyte,
the positive electrode including a positive electrode active material including
a secondary particle of a lithium transition metal oxide, the secondary particle being formed by coagulation of primary particles of the lithium transition metal oxide, and
secondary particles of a rare earth compound, the secondary particles each being formed by coagulation of primary particles of the rare earth compound,
the secondary particles of the rare earth compound each being deposited on a groove between a pair of adjacent primary particles of the lithium transition metal oxide, the groove being formed in a surface of the secondary particle of the lithium transition metal oxide, so as to come into contact with both of the pair of adjacent primary particles of the lithium transition metal oxide in the groove,
the nonaqueous electrolyte including lithium difluorophosphate.

2. The nonaqueous electrolyte secondary battery according to claim 1, wherein a rare earth element included in the rare earth compound is at least one element selected from neodymium, samarium, and erbium.

3. The nonaqueous electrolyte secondary battery according to claim 1, wherein the rare earth compound is at least one compound selected from hydroxides and oxyhydroxides.

4. The nonaqueous electrolyte secondary battery according to claim 1, wherein the ratio of the amount of nickel included in the lithium transition metal oxide to the total number of moles of metal elements included in the lithium transition metal oxide which are other than lithium is 80 mol % or more.

5. The nonaqueous electrolyte secondary battery according to claim 1, wherein the concentration of the lithium difluorophosphate in the nonaqueous electrolyte is 0.01 M or more and 0.25 M or less.

6. The nonaqueous electrolyte secondary battery according to claim 1, wherein the ratio of the amount of cobalt included in the lithium transition metal oxide to the total number of moles of the metal elements other than lithium is 7 mol % or less.

7. The nonaqueous electrolyte secondary battery according to claim 4, wherein the ratio of the amount of cobalt included in the lithium transition metal oxide to the total number of moles of the metal elements other than lithium is 7 mol % or less.
